(19) United States
(12) Patent Application Publication
(10) Pub. No.: US 2020/0124877 A1
(43) Pub. Date: Apr. 23, 2020

(54) CONFETTI INLAID WEARABLE NOVELTY ITEMS

(71) Applicant: Lorraine Melody Hsu, Santa Ana, CA (US)

(72) Inventor: Lorraine Melody Hsu, Santa Ana, CA (US)

(21) Appl. No.: 16/164,241

(22) Filed: Oct. 18, 2018

(51) Int. Cl. G02C 11/02; G02C 11/04; F21V 23/04; A44C 25/00; A44C 15/00; A44C 7/00; A44C 5/00

(52) U.S. Cl. CPC G02C 11/02; G02C 11/04; F21V 23/0407; F21Y 2115/10; A44C 15/0015; A44C 7/00; A44C 5/00; A44C 25/001

(57) ABSTRACT

A wearable or ornamental item is made up of at least two layers of transparent plastic that are recessed to form, when joined together, an internal passage having dimensions sufficient to loosely accommodate decorative pieces such as confetti. The wearable or ornamental item may be an eyeglass frame, and may be illuminated by LEDs fixed within the passage and connected by wires to a battery power source also fixed within the passage.

### BACKGROUND OF THE INVENTION

### 1. Field of the Invention

The invention relates to wearable or ornamental items that are inlaid with confetti or confetti-like objects. The confetti or confetti-like objects are loosely captured in a passage formed in the object when two clear plastic pieces are joined together.

The wearable items may be eyeglass frames. The eyeglass frames may be illuminated by LEDs fixed in the passage.

The invention also encompasses ornamental items that are not necessarily wearable, such as Christmas ornaments or party decorations.

### 2. Description of Related Art

It is known to embed ornamental objects in at least partially clear plastic. For example, U.S. Patent Publication No. 2007/0254140 and Korean Patent Publication No. 10-2016-0055510 each disclose eyeglass frames with embedded objects. However, in each, the objects are fixedly laminated between layers of plastic, thus subjecting the objects to heat and pressure. As a result, the objects are limited to objects that can withstand the heat and pressure, such as the “beads, glitter film, cubic [zirconia], crystal and leather pieces” described in the Korean publication. These objects are relatively costly. The present invention avoids subjecting the ornamental objects to heat or pressure by loosely capturing them in a passage formed between transparent plastic layers, without attempting to embed the objects, thereby allowing a wider variety of objects, and in particular objects such as attractive confetti and confetti-like pieces to be included in the items. This in turn enables the economical manufacture of inexpensive wearable items intended for single-use occasions such as holidays or birthdays, or for sale as novelty items, to be provided with colorful and attractive inlays.

It is also known to illuminate eyeglass frames, either for decorative effect or to provide illumination. Examples of illuminated eyeglass frames are disclosed in U.S. Pat. Nos. 4,283,127; 4,822,160; 6,196,680; 7,699,486; and 7,946,705; U.S. Patent Publication No. 2011/0013135; European Patent Publication No. EP 2,590,008; and Chinese Patent Publication No. CN201035262, which discloses LEDs distributed around the lens of an eyeglass frame. The present invention combines an illumination arrangement with inlaid confetti or confetti-like pieces, thereby enhancing both the illumination effect and the decorative effect provided by the confetti or confetti-like pieces, particularly if the confetti or confetti-like pieces have shiny and/or colorful surfaces.

U.S. Pat. No. 5,772,065 discloses a shot glass that includes decorative pieces of confetti pressed against raised portions of a lenticular array welded to the base of the shot glass. The present invention does not seek to provide any lenticular array, and only loosely captures the confetti or confetti-like pieces, without attempting to fix them at specific locations.

Finally, U.S. Pat. No. 4,828,355 discloses a tubular eyeglass frame into which colored water containing glitter particles may be injected. The use of a tubular shape limits the shape of the frame and limits the possibility of application to items other than eyeglass frames. In addition, the inclusion of a liquid precludes the possibility of including distributing lights source and including a power supply within the frame.

In summary, while the prior art includes wearable or ornamental items with embedded decorative objects, the objects are fixed and require complex manufacturing methods, as well as objects that can withstand heat and/or pressure. Moreover, while illuminated eyeglass frames are known, none combines illumination with embedded objects. Other prior art involving confetti or glitter requires placement of the confetti on the lenticular array of a shot glass or injection of glitter-containing liquid into a tubular eyeglass frame. The prior art fails to disclose or suggest decorative object embedding or illumination arrangements that are suitable for use in novelty items such as the confetti-inlaid wearable or ornamental items of the present invention.

### SUMMARY OF THE INVENTION

It is accordingly an objective of the invention to provide a wearable or ornamental item inlaid with decorative objects, and that is relatively simple and inexpensive to manufacture.

It is a second objective of the invention to provide a wearable or ornamental item inlaid with confetti or confetti-like objects.

It is third objective of the invention to provide a wearable or ornamental item in which inlaid confetti or confetti-like objects and light sources are combined for decorative effect.

It is a fourth objective of the invention to provide an eyeglass frame inlaid with confetti or confetti-like items, and which may be further provided with colorful lighting effects.

These objectives, which are not intended to be limiting, are achieved by a first preferred embodiment of the invention in which a wearable or ornamental item is made up of at least two layers of transparent plastic that are recessed to form an internal enclosed passage having dimensions sufficient to loosely accommodate decorative pieces such as confetti when the plastic layers are joined together by any suitable joining method, including methods that do not require pressure or heat, such as adhesives or solvent bonding, interference or snap fitting, ultrasonic welding, and so forth. The joined-together layers may form the front piece or panel of an eyeglass frame or another wearable item such as a pendant or earring.

By placing the decorative items loosely between the layers of plastic, the decorative items are not subject to heat or pressure during the joining process, allowing relatively inexpensive but fragile objects to be inlaid.

In an especially preferred embodiment of the invention, the internal passage is further arranged to accommodate light sources, an on/off switch, at least one battery and, optionally, a flasher or other lighting effects control circuit.

Examples of suitable transparent plastic materials include Acrylic (polymethlamethacrylate), Butyrate (cellulose acetate butyrate), Lexan (polycarbonate), and PETG (polyethylene terephthalate and glycol). Numerous methods of joining together layers of such plastics are known, including lamination, adhesives or solvent bonding, snap fit, welding, and so forth, and in themselves form no part of the present invention.

The term “confetti” as used herein may include paper, cardboard, Mylar, or metal foil pieces or strips having a generally rectangular or square shape, with different pieces having surfaces of different colors, and a maximum dimension on the order of a few millimeters, such as three millimeters, and a thickness corresponding to the thickness of a sheet of paper, cardboard, Mylar, or foil from which the confetti pieces are cut, typically on the order of a few microns or fractions of a millimeter.

The term “confetti-like pieces” as used herein refers to pieces or particles with dimensions smaller than confetti, such as glitter, or pieces with irregular shapes or materials that differ from conventional confetti pieces.

### BRIEF DESCRIPTION OF THE DRAWINGS

FIG. 1 is a front view of an eyeglass frame constructed in accordance with the principles of a preferred embodiment of the present invention.

FIG. 2 is a rear view of the eyeglass frame of the preferred embodiment.

FIG. 3 is a top view of the eyeglass frame of the preferred embodiment.

FIG. 4 is a cross-sectional side view of the eyeglass frame of the preferred embodiment.

FIG. 5 is a plan view of a pendant constructed in accordance with the principles of a second preferred embodiment of the invention.

### DETAILED DESCRIPTION OF THE PREFERRED EMBODIMENTS

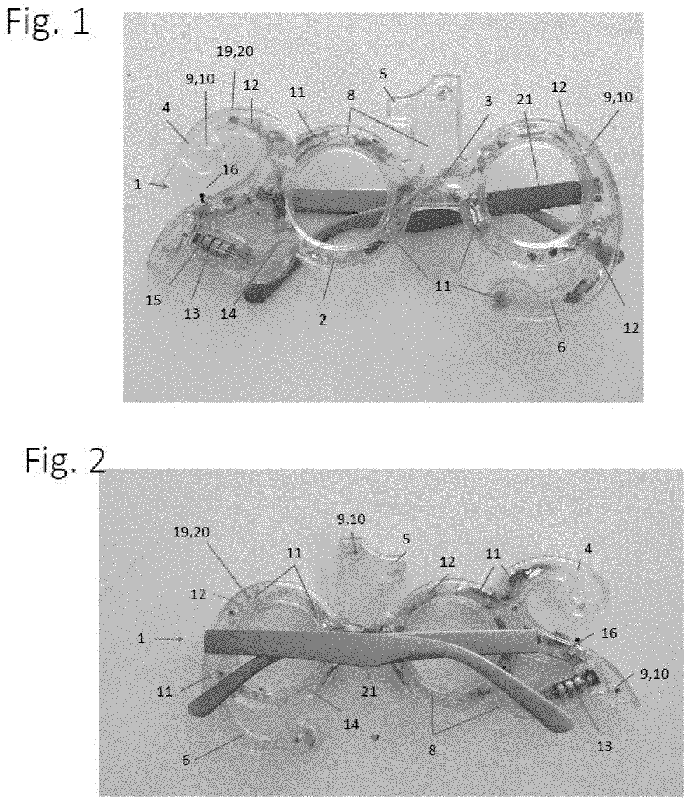

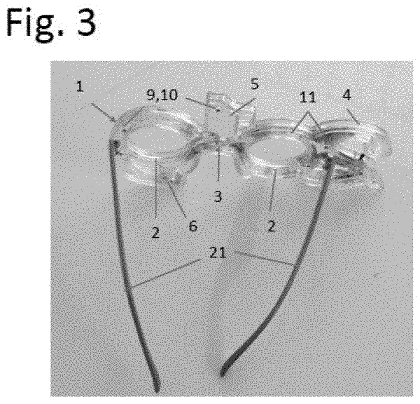

As illustrated in FIGS. 1-4, the wearable item of the invention may take the form of an eyeglass frame having a front frame portion 1 made up of two generally annular sections 2 and 3 that surround a wearer's eyes and that are connected by a bridge portion 4 that rests on the wearer's nose. Although an eyeglass frame is illustrated, the principles of the invention may be applied to other types of wearable items, such as a pendant for a necklace or bracelet or an earring.

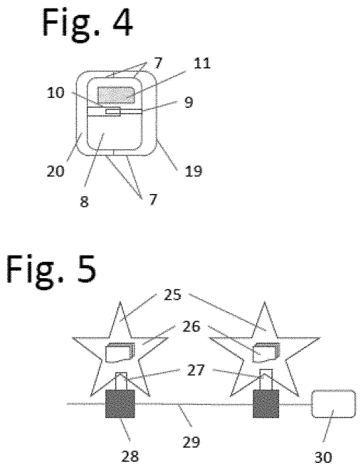

In the illustrated embodiment, the front frame portion 1 is formed from two generally planar layers 19 and 20, shown in FIG. 4, made of transparent plastic that are cut into the illustrated shape. While an eyeglass frame needs to include sections that at least partially surround the user's eyes, and a connecting section, the shapes of these sections 2 and 3 may be varied as desired for decorative effect. For example, the illustrated front frame portion 1 has the shape of the number “2019,” so that the frame may be worn during a New Year's celebration, and includes an extension 4 in the shape of the numeral “2,” an extension 5 in the shape of an upper section of the numeral “1,” and an extension 6 that forms the lower section of the numeral “9.” The shapes are not limited to numbers, and furthermore may be omitted entirely with the front frame portion have a shape of a conventional eyeglass frame.

As shown in FIG. 4, the two plastic layers 19 and 20 are formed to have a cross-sectional C-shape, with the ends of the transverse arms 7 of the C-shape abutting each other when the plastic layers are joined together to form an interior chamber or passage 8 that is large enough to loosely accommodate confetti or confetti-like pieces 11. The joined-together surfaces of the plastic layers 19 and 20 from a continuous joint that prevents the confetti or confetti-like pieces from escaping the passage 8. Sealing is possible but not required. In embodiments that include wiring, the passage 8 may be continuous but if wiring if not required, then the passage 8 may be divided into sections that are not continuous.

The plastic layers 19 and 20 may be joined together by any known plastic-joining method. In the illustrated embodiment, posts 9 and complementary cylindrical bosses 10 are provided to enable joining of the layers 19 and 20 by an interference snap fit, and/or by the use of an adhesive or solvent bond after capturing the confetti or confetti-like pieces 11 in the passage 8.

The term “confetti” as used herein refers to flat pieces or streamers of paper, cardboard, Mylar, or metallic material or foil having a maximum dimension of between one millimeter two to four millimeters so as to fit loosely within the passage 8. The pieces 11 preferably have different colors respective colors and may be opaque and reflective to enhance their visibility. The term “confetti-like” objects can include objects that have a maximum dimension is smaller than that of conventional confetti, for example less than one millimeter, and may include pieces of the type known as glitter.

Also included in the passage 8 of the illustrated eyeglass frame embodiment is a lighting arrangement that includes a plurality of light sources 12. Light sources 12 are preferably LEDs that are fixed in the passage 8 and electrically connected to each other and to a power source 13 by wires 14. The power source 13 may include one or more batteries, which are illustrated as, but not limited to, a stack of disc-shaped cells. The continuously extending passage or chamber 8, which also contains the confetti or confetti-like objects 11, light sources 12, and wires 14, includes an expanded cylindrical section have a shape and size sufficient to form a battery compartment 15 to accommodate the stack of disc-shaped cells forming the power source 13, as well as battery contacts to connect the power source 13 with the wires 14. In addition, an on/off slide or toggle switch 16 may be connected to the wires and fixed in the continuously extending passage or chamber 8, the switch 16 extending through an opening in or between the plastic layers 19 and 20 to allow manipulation of the switch 16, and to thereby allow a user to turn the LEDs on and off. In addition, a flasher circuit (not shown) or other control circuit may be included to provide flashing or other lighting effects.

Finally, to complete the eyeglass frame, conventional hinged earpieces 21 may be added at the sides or rear of the front portion 1. The construction of the ear pieces forms no part of the present invention.

In the embodiment shown in FIG. 5, a plurality of pendants forming a necklace are each made up of plastic layers 25 cut into a star shape. The plastic layers 25 may be joined together by any of the methods described above in connection with the first preferred embodiment of the invention, the layers 25 forming an interior space filled with confetti or confetti-like objects 26 corresponding to confetti or confetti-like objects 11 described above.

Each pendant further includes a lighting element 27 that extends into the interior of the pendant from a socket 28 through an opening in the plastic layers 25. Instead of an internal power cell and wiring, the light sources extending into each pendant are electrically connected by external wires 29 encased in flexible plastic to allow the pendants to be worn by the user. Also connected by the external wires 29 are a power source (not shown) contained in a housing 30 and operable by a switch and optional controller such as a flasher circuit.

What is claimed is:

1. A wearable or ornamental item, comprising:
at least two transparent plastic layers, each includes a central recess that, when the two plastic layers are joined together, forms a passage extending through the wearable item and enclosed within the plastic layers;
a plurality of decorative confetti-like objects loosely situated within the enclosed passage.

1. A wearable or ornamental item as claimed in claim 1, wherein the wearable item is an eyeglass frame.

2. A wearable or ornamental item as claimed in claim 2, wherein the confetti-like objects are confetti with a maximum dimension of 3 mm.

3. A wearable or ornamental item as claimed in claim 2, wherein the confetti-like objects are glitter, with a maximum dimension of less than 1 mm.

4. A wearable item as claimed in claim 2, wherein the confetti-like objects are flat pieces of paper, cardboard, Mylar, or a metallic material or foil having a maximum dimension of no more than 4 mm.

5. A wearable or ornamental item as claimed in claim 5, wherein the passage is continuous, and further comprising a power source, LEDs, and connecting wires fixed at spaced-apart locations in the enclosed continuous passage.

6. A wearable or ornamental item as claimed in claim 6, wherein the power source includes at least one battery.

7. A wearable or ornamental item as claimed in claim 6, further comprising a flasher circuit for causing the LEDs to flash on and off.

8. A wearable or ornamental item as claimed in claim 6, wherein the LEDs have different colors.

9. A wearable or ornamental item as claimed in claim 6, further comprising an on/off switch connected to the wires and including a portion that extends through an opening in the frame.

10. A wearable or ornamental item as claimed in claim 2, wherein the plastic layers are joined together by posts and complementary cylindrical bosses, which may be joined together by an interference fit and/or the use of an adhesive or solvent bond.

11. A wearable or ornamental item as claimed in claim 1, wherein the confetti-like objects are confetti with a maximum dimension of 3 mm.

12. A wearable or ornamental item as claimed in claim 12, wherein the confetti-like objects are glitter, with a maximum dimension of less than 1 mm.

13. A wearable or ornamental item as claimed in claim 12, wherein the confetti-like objects are flat pieces of paper, cardboard, Mylar, or a metallic material or foil having a maximum dimension of 3 mm.

14. A wearable or ornamental item as claimed in claim 14, further comprising an LED that extends into the enclosed passage containing the confetti-like objects.

15. A wearable or ornamental item as claimed in claim 15, wherein the wearable or ornamental item is a pendant, and the LED is connected by wires to an external power source.

16. A wearable or ornamental item as claimed in claim 16, wherein the wires connect multiple pendants and are sealed within a flexible plastic to form a necklace.
